(19) United States
(12) Patent Application Publication
(10) Pub. No.: US 2011/0153478 A1
(43) Pub. Date: Jun. 23, 2011

(54) Device and Method for Settlement Optimization

(76) Inventors: Jerry MCKAY, Grand Prairie, TX (US); Sally Baptiste, Grand Prairie, TX (US); Steve Richie, Burleson, TX (US); Aimee Willmeno, Eureka, MO (US)

(21) Appl. No.: 12/641,815

(22) Filed: Dec. 18, 2009

(51) Int. Cl. G06Q 20/00; G06F 17/00; G06Q 30/00; G06Q 40/00

(52) U.S. Cl. 705/34; 235/380; 705/35; 705/41; 705/44

(57) ABSTRACT

A settlement device for optimizing a transaction includes an input module, a processor, and an output module. The input module receives transaction data of the transaction. The processor determines an optimal location to process the transaction as a function of predetermined rules. The output module transmits the transaction data to the optimal location.

### BACKGROUND

A retail location may utilize credit card and/or debit transactions for payment of goods sold thereby. When the credit card is used (e.g., read a magnetic stripe, receive a signal, etc.), a transaction including an identification of the credit card is sent to a processing location for authentication. Subsequently, a cost of the transaction is sent for a settlement to enable a user of the credit card to purchase the goods and remit a payment to a third party at a later time. However, transactions are routed to processors based upon either an originating affiliate organization or a point of entry. As a result, further costs are associated with the use of credit cards, in particular for transmission of data to further parties who are ultimately responsible for the exchange of payments.

### SUMMARY OF THE INVENTION

The exemplary embodiments of the present invention describe a settlement device for optimizing a transaction. An input module receives transaction data of the transaction. A processor determines an optimal location to process the transaction as a function of predetermined rules. An output module transmits the transaction data to the optimal location.

### DESCRIPTION OF THE DRAWINGS

FIG. 1 shows a transaction system according to an exemplary embodiment.

FIG. 2 shows a method for routing a transaction according to an exemplary embodiment.

### DETAILED DESCRIPTION

The exemplary embodiments may be further understood with reference to the following description and the appended drawings, wherein like elements are referred to with the same reference numerals. The exemplary embodiments describe a device and method for optimizing a settlement transaction. Specifically, the settlement transaction may relate to payment methods involving a use of credit cards and/or debit cards. The settlement transaction, payment methods, and a related method will be discussed in further detail below.

It should be noted that the following describes the device and method of the exemplary embodiments with respect to a credit card. However, the credit card is used as an exemplary method of payment covered by the device and method of the exemplary embodiments. Thus, the credit card may further exemplify any method of payment in which a third party is involved. For example, the credit card described herein may further encompass a debit card, a smart card, etc.

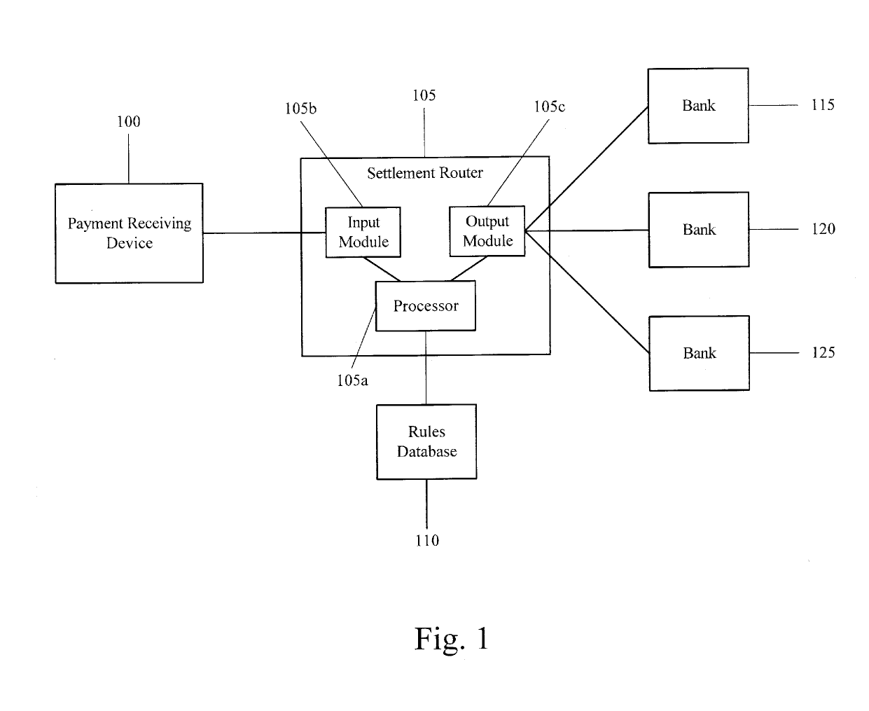

FIG. 1 shows a transaction system according to an exemplary embodiment. The transaction system may be for processing a use of a credit card for a purchase. As will be described in further detail below, components of the transaction system may be disposed in various locations. The transaction system may include a payment receiving device 100, a settlement router 105, and banks 115-125.

The payment receiving device 100 may be any device configured to receive information from a credit card. For example, the payment receiving device 100 may be a magnetic strip reader. In another example, the payment receiving device 100 may be a radio frequency identification (RFID) reader. In yet other examples, the payment receiving device 100 may be for transaction types including recurring, eCommerce, Card Not Present, etc. Accordingly, the payment receiving device 100 may be disposed at, for example, a retail location. At the retail location, a plurality of payment receiving devices 100 may be disposed therein. The payment receiving device 100 may include a communication component. The communication component may enable the payment receiving device 100 to directly or indirectly establish a connection with a further component such as the settlement router 105. The direct connection may be, for example, where the payment receiving device 100 includes a wireless protocol to transmit signals to the settlement router 105. The indirect connection may be, for example, where the payment receiving device 100 includes a local area connection to a central router that subsequently transmits signals to the settlement router 105.

The banks 115-125 may represent a third party that provides the exchange of payments when the payment receiving device 100 transmits the credit card information. Thus, the banks 115-125 may be disposed at a variety of locations. The banks 115-125 may also be configured with communications components to establish a connection with the settlement router 105. It should be noted that the banks 115-125 may represent any third party that provides the payment for goods when a credit card is used.

The settlement router 105 may be an intermediary disposed between the payment receiving device 100 and the banks 115-125. Thus, the settlement router 105 may receive credit card information via the input module 105b from the payment receiving device 100 and transmit data via the output module 105c to one of the banks 115-125. According to the exemplary embodiments, the settlement router 105 may be configured to determine via the processor 105a the bank 115-125 to which the credit card information is to be transmitted. Thus, transactions may be routed to processors that specialize in niche pricing as a function of the properties of each individual transaction.

The settlement router 105 may have access to a rules database 110 which provides a set of rules that determine to which bank 115-125 the credit card information is to be transmitted by the output module 105c. In a first exemplary embodiment and illustrated in FIG. 1, the rules database 110 may be a separate database that stores the rules. In a second exemplary embodiment, the rules database 110 may be part of the settlement router 105 such as embodied in a memory.

The rules of the rules database 110 may enable an optimal bank of the banks 115-125 to which the credit card information is to be sent. To determine the optimal bank, the rules database 110 may include table-driven rules relating to a variety of factors. For example, a type of transaction may be considered. In a second example, an identification of a billing party and a division of that billing party may be listed in the rules database 110 with an appropriate action to be taken thereby. In a third example, a cost center indicator may be included in the rules database 110 also with an appropriate action to be taken thereby. In a fourth example, characteristics of the transaction may be considered by the rules database 110 such as a customer type (e.g., consumer or business), a card type (e.g., rewards card, purchasing card, etc.), a card issuer, whether or not the card is present, recurring transactions, etc. In a fourth example, a type of tender may be considered such as a personal identification number (PIN) debit card, a PIN-less debit card, a credit card, etc.

The rules database 110 may take into consideration at least the above described exemplary factors in determining the optimal bank to transmit the credit card information. For example, a result of a first factor may indicate that bank 115 is optimal while a result of a second factor may indicate that bank 120 is optimal. However, the rules database 110 may include a solution route to take when bank 115 is indicated for the first factor while the bank 120 is indicated for the second factor. For example, the solution route may indicate that bank 125 is the optimal choice. Thus, the processor 105a may determine that bank 125 is the optimal choice and transmit the credit card information via the output module 105c to the bank 125.

The selection of the optimal bank may enable transactions to be routed to low-cost processors based upon the specific transaction attributes. Volume sensitive pricing tiers may also be monitored and managed to not overwhelm these tiers. The rules database 110 being flexible enables a faster response to changing financial conditions.

According to the exemplary embodiments, at the point of authorization for a credit card, the settlement router 105 may evaluate the transaction using the rules database 110. Using known data from the credit card information that is received from the payment receiving device 100 via the input module 105b, the evaluation may be made. As a result, conventional methods that consider factors such as an originating source or point of entry, the settlement router 105 routes the credit card information to one of the banks 115-125 regardless of previously considered factors. When the settlement router 105 determines the optimal bank, the transaction may be marked with a bank indicator.

The rules database 110 provides flexible, table-driven rules that may be accessed and adjusted to redirect volumes to optimize pricing tiers. In addition, more robust reporting for transactions may be available to support better decision making by the settlement router 105. The rules database 110 may automatically adjust according to the reporting or may be adjusted manually by an administrator upon reviewing the reports. The reports may include a variety of information including those used in the decision table such as the billing party, a division of the billing party, the cost center indicator, etc. Furthermore, the report may include the settlement decision (i.e., optimal bank for a given transaction) as well as data required for reversals and chargebacks.

According to the exemplary embodiments, further indications may be marked with the transaction to resolve identification factors needed by the banks 115-125 when performing the transaction. For example, conventional systems use an originating source and thus a merchant identification (MID) for each transaction. According to the exemplary embodiments, at the point of initiating an authorization, a payment source (e.g., Web, IVR, CSR, etc.) is unaware of the MID to be associated with the transaction as MIDs are processor specific. To resolve this matter, the settlement router 105 may replace MIDs with proprietary identifications that are encoded with or mapped to specific cost centers. At the point of decision, the proprietary identification is replaced by the settlement router 105 with an appropriate MID before it is passed to an authentication processor. Therefore, the settlement router 105 may use surrogate identifications to maintain the conventional use of the MID. The surrogate identifications may be stored with the rules in the rules database 110.

Those skilled in the art will understand that the use of surrogate identifications does not create an undue processing step. Furthermore, surrogate identifications may be easily mapped to new MIDs if processor relationships change. In addition, the number of MIDs used may be reduced, thereby simplifying bank reconciliations and settlements. Surrogate identifications may also report details at a lower level than is currently supported by MIDs.

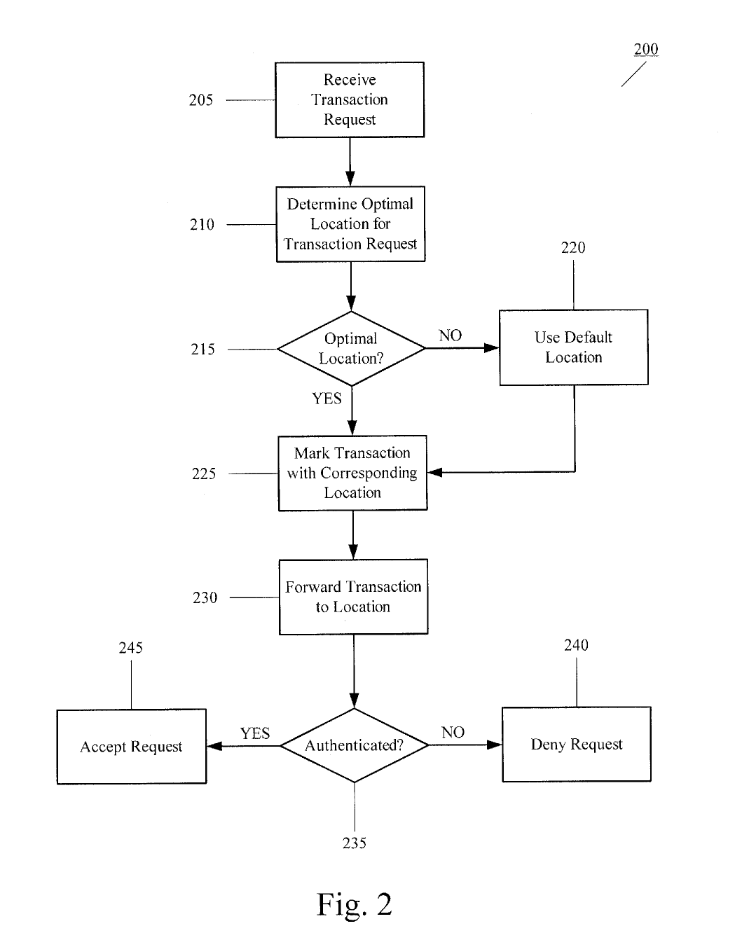

FIG. 2 shows a method 200 for routing a transaction according to an exemplary embodiment. The method 200 relates to when a payment receiving device receives credit card information and awaits authorization for the transaction. The method 200 will be discussed with reference to the transaction system of FIG. 1. The method 200 will be described with respect to the settlement router 105.

In step 205, the settlement router 105 receives a transaction request via the input module 105b from the payment receiving device 100. As discussed above, the method 200 relates to when the payment receiving device has already received the credit card information. The credit card information may have been received from, for example, reading a magnetic stripe, receiving a RFID signal, etc. The payment receiving device 100 may translate the raw data from the credit card and package the data for transmission, directly or indirectly, to the settlement router 105.

In step 210, the settlement router 105 determines an optimal location that will handle the transaction request. As discussed above, using known information derived from the credit card information, the settlement router 105 may access the rules database 110 to determine the optimal location. The determination may be made using the flexible, table-driven rules of the rules database 110. The rules of the rules database 110 may include solution paths for multiple outcomes from the various known factors of the credit card information. For example, the billing party, cost center indicator, transaction characteristics, etc. may be related to the rules.

In step 215, a determination is made whether an optimal location was found. The rules database 110 may include a variety of rules and corresponding paths depending on a decision at each level of rule decision making. However, the transaction may include known factors in which no optimal location may be found. It should be noted as more transactions are processed through the settlement router 105 and the reporting is gathered, instances in which no optimal location is found may be reduced. The rules database 110 may indicate a default location based upon select, known factors when no optimal location is determined. Thus, if no optimal location is determined, the method 200 continues to step 220 where a default location is used.

In step 225, the settlement router 105 marks the location determined in step 210 or 220 to the transaction. As discussed above, marking the location with the transaction resolves the issue of not knowing the MID which is processor specific. Thus, the proprietary identification replace the MID which is encoded with or mapped to specific cost centers. Subsequently, the proprietary identification is replaced by the MID which is passed to the determined location.

In step 230, the settlement router 105 forwards the marked transaction via the output module 105c to the determined location. The determined location may be the optimal location to process the transaction given the known factors and the current rules provided by the rules database 110. The location (e.g., banks 115-125) may receive the transaction for authentication prior to approval.

In step 230, the settlement router receives a determination from the determined location. The determination indicates whether the transaction has been authenticated (i.e., approved). If the determination indicates that there is no authentication, then the method 200 continues to step 240 where the transaction request is denied. If the determination indicates that there is authentication, then the method 200 continues to step 245 where the transaction request is accepted. A subsequent step after steps 240 and 245 may be to transmit to the payment receiving device 100 the outcome of the authentication determination of step 235.

The exemplary embodiments provide for an improved system for transaction settlement. The transaction system of the exemplary embodiments provides efficiency and cost reduction for each transaction being settled. A selection of an optimal location to process the transaction allows for fewer data transmissions as intermediaries are no longer required. The table-driven rules database provides parameters to determine the optimal location. The flexibility of the rules database enables updates and changes to be made on a more immediate basis to provide the most current financial conditions. The flexibility also enables future transaction types to be incorporated for the optimal selection. The settlement router may be a central processor for each transaction that enables gathering of the data of each transaction. Thus, more robust reporting from the transactions may be available to support better subsequent decision making.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A settlement device, comprising:
an input module receiving transaction data of a transaction;
a processor determining an optimal location to process the transaction as a function of predetermined rules; and
an output module transmitting the transaction data to the optimal location.

2. The settlement device of claim 1, wherein the transaction data is received from a payment receiving device.

3. The settlement device of claim 2, wherein the payment receiving device relates to a type of the transaction being one of reading a magnetic strip, receiving a radio frequency identification (RFID), a recurring transaction, an eCommerce transaction, and a Card Not Present transaction.

4. The settlement device of claim 2, wherein the payment receiving device receives part of the transaction data from one of a credit card, a debit card, and a smart card.

5. The settlement device of claim 1, wherein the transaction data includes at least one of a billing party, a division of the billing party, a cost center indicator, a customer type, a card type, and a card issuer.

6. The settlement device of claim 1, wherein the predetermined rules relate to at least one of an issuing bank, a presence of a card, a recurring transaction, a consumer, a business, and a type of card.

7. The settlement device of claim 1, wherein the processor marks the transaction with a proprietary identification that is encoded with a specific cost center.

8. The settlement device of claim 7, wherein the proprietary identification is replaced with a merchant identification prior to the transmitting.

9. The settlement device of claim 1, wherein the optimal location authenticates the transaction.

10. The settlement device of claim 9, wherein the input module further receives a result of the authenticating.

11. A method, comprising:
receiving transaction data of a transaction;
determining an optimal location to process the transaction as a function of predetermined rules; and
transmitting the transaction data to the optimal location.

12. The method of claim 11, wherein the transaction data is received from a payment receiving device.

13. The method of claim 12, wherein the payment receiving device relates to a type of the transaction being one of reading a magnetic strip, receiving a radio frequency identification (RFID), a recurring transaction, an eCommerce transaction, and a Card Not Present transaction.

14. The method of claim 12, wherein the payment receiving device receives part of the transaction data from one of a credit card, a debit card, and a smart card.

15. The method of claim 11, wherein the transaction data includes at least one of a billing party, a division of the billing party, a cost center indicator, a customer type, a card type, and a card issuer.

16. The method of claim 11, wherein the predetermined rules relate to at least one of an issuing bank, a presence of a card, a recurring transaction, a consumer, a business, and a type of card.

17. The method of claim 11, further comprising:
marking the transaction with a proprietary identification that is encoded with a specific cost center.

18. The method of claim 17, further comprising:
replacing the proprietary identification with a merchant identification prior to the transmitting.

19. The method of claim 11, wherein the optimal location authenticates the transaction.

20. A settlement device, comprising:
a receiving means for receiving transaction data of a transaction;
a determining means for determining an optimal location to process the transaction as a function of predetermined rules; and
a transmitting means for transmitting the transaction data to the optimal location.
